(19) United States
(12) Patent Application Publication
(10) Pub. No.: US 2009/0067495 A1
(43) Pub. Date: Mar. 12, 2009

(54) RATE DISTORTION OPTIMIZATION FOR INTER MODE GENERATION FOR ERROR RESILIENT VIDEO CODING

(75) Inventors: Oscar Chi Lim Au, Hong Kong (CN); Yan Chen, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/853,498

(22) Filed: Sep. 11, 2007

(51) Int. Cl. H04N 7/18

(52) U.S. Cl. 375/240.12; 375/E07.09

(57) ABSTRACT

Optimal selection of an inter mode is provided for video data being encoded to achieve enhanced error resilience when the video data is decoded. End to end distortion cost from encoder to decoder for inter mode selection is determined based on residue energy and quantization error. Using the distortion cost function based on residue energy and quantization error, and an optimal Lagrangian parameter, the optimal inter mode is selected for use during encoding for maximum error resilience. The optimal Lagrangian parameter can be set to be proportional to an error-free Lagrangian parameter with a scale factor determined by packet loss rate.

### TECHNICAL FIELD

The subject disclosure relates to rate distortion optimizations for selection of an inter mode during video encoding for enhanced resilience to errors.

### BACKGROUND

Generally speaking, using specific encoding schemes, data compression or source coding is the process of encoding information using fewer bits than an unencoded representation would use. As with any communication, compressed data communication only works when both the sender and receiver of the information understand the encoding scheme. For instance, encoded or compressed data can only be understood if the decoding method is also made known to the receiver, or already known by the receiver.

Compression is useful because it helps reduce the consumption of expensive resources, such as hard disk space or transmission bandwidth. On the downside, compressed data must be decompressed to be viewed, and this extra processing can be detrimental to some applications. For instance, a compression scheme for video may require expensive hardware for the video to be decompressed fast enough to be viewed as it is being decompressed, i.e., in real-time. For instance, for some time-sensitive applications, time might be so critical that decompressing the video in full before watching it is prohibitive or at least inconvenient, or for a thin client, full decompression in advance might not be possible due to storage requirements for the decompressed video. Compressed data can also introduce a loss of signal quality. The design of data compression schemes therefore involve trade-offs among various factors, including the degree of compression, the amount of distortion introduced if using a lossy compression scheme, and the computational resources required to compress and uncompress the data.

Jointly developed by and with versions maintained by the ISO/IEC and ITU-T standards organizations, H.264, a.k.a. Advanced Video Coding (AVC) and MPEG-4, Part 10, is a commonly used video coding standard that was designed in consideration of the growing need for higher compression of moving pictures for various applications such as digital storage media, television broadcasting, Internet streaming and real-time audiovisual communication. H.264 was also designed to enable the use of a coded video representation in a flexible manner for a wide variety of network environments. H.264 was further designed to be generic in the sense that it serves a wide range of applications, bit rates, resolutions, qualities and services.

The use of H.264 allows motion video to be manipulated as a form of computer data and to be stored on various storage media, transmitted and received over existing and future networks and distributed on existing and future broadcasting channels. In the course of creating H.264, requirements from a wide variety of applications and any necessary algorithmic elements were integrated into a single syntax, facilitating video data interchange among different applications.

By way of further background, the coded representation specified in the syntax is designed to enable a high-compression capability with minimal degradation of image quality, i.e., with minimal distortion. The algorithm is not ordinarily lossless, as the exact source sample values are typically not preserved through the encoding and decoding processes, however, a number of syntactical features with associated decoding processes are defined that can be used to achieve highly efficient compression, and individual selected regions can be sent without loss.

Compared with previous coding standards MPEG2 and H.263, the new video coding standard H.264/AVC possesses better coding efficiency over a wide range of bit rates by employing sophisticated features such as using a rich set of coding modes. However, it is known that the bit streams generated by H.264/AVC are vulnerable to transmission errors due to predictive coding and variable length coding. In this regard, one packet loss or even a single bit error can render a whole slice of video undecodeable, severely degrading the visual quality of the received video sequences as a result.

Conventional systems that have been proposed to reduce the degradation of visual quality due to such transmission errors include data partition approaches. With data partition techniques, different types of symbols are separated into different packets, sending more important symbols such as motion vectors with higher priority, in which case it becomes reasonable to assume that the motion vectors are correctly received at the decoder as a matter of data priority. Then at the decoder, a motion compensated frame can be used to conceal any lost frame.

One conventional rate-distortion optimized based mode decision algorithm includes recursive optimal per-pixel estimation (ROPE). ROPE operates to estimate the expected sample distortion by tracking the first and second order moments of a reconstructed pixel value. However, ROPE is very sensitive to the approximation errors, and practically speaking, accuracy is difficult to maintain when doing various pixel averaging operations such as sub-pixel motion estimation. Adopted in H.264 reference software, an error robust rate distortion optimization method has also been proposed in which the distortion is computed by decoding the macro block (MB) K times with different error patterns and averaging them. Yet, the method is clearly overly complex. In order to help simplify the complexity, a distortion map has been proposed to aid in computing the propagation error.

These conventional mode decision systems and methods, however, are mainly focused on how to select an optimal intra refresh position, whereas no conventional mode decision systems have focused on selection of inter mode, i.e., how to generate an optimal inter mode for P frames at the encoder to enhance error resilience.

Accordingly, it would be desirable to provide an optimal solution for encoding video data that optimizes inter mode decision making at the encoder. The above-described deficiencies of current designs for video encoding are merely intended to provide an overview of some of the problems of today's designs, and are not intended to be exhaustive. Other problems with the state of the art and corresponding benefits of the invention may become further apparent upon review of the following description of various non-limiting embodiments of the invention.

### SUMMARY

Optimal selection of an inter mode is provided for video data being encoded to achieve enhanced error resilience when the video data is decoded. End to end distortion cost from encoder to decoder for inter mode selection is determined based on residue energy and quantization error. Using a cost function based on residue energy and quantization error and an optimal Lagrangian parameter, the invention selects the optimal inter mode for use during encoding for maximum error resilience. In one non-limiting embodiment, the optimal Lagrangian parameter is set to be proportional to an error-free Lagrangian parameter with a scale factor determined by packet loss rate.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The optimal video encoding techniques for selecting inter mode in accordance with the invention are further described with reference to the accompanying drawings in which:

FIG. 1 is an exemplary block diagram of a video encoding/decoding system for video data for operation of various embodiments of the invention;

FIG. 2 illustrates exemplary errors introduced from an original sequence of images to a set of motion compensated reconstructed images in accordance with an inter mode of a video coding standard in accordance with the invention;

FIG. 3 is a flow diagram generally illustrating the optimal selection of inter mode in accordance with a video encoding process in accordance with the invention;

FIG. 4 is a flow diagram illustrating exemplary, non-limiting determination of an optimal inter mode for a video encoding process in accordance with the invention;

FIG. 5A is a flow diagram illustrating exemplary, non-limiting determination of an end-to-end distortion cost in accordance with embodiments of the invention;

FIG. 5B is a flow diagram illustrating exemplary, non-limiting determination of a Lagrangian parameter in accordance with embodiments of the invention;

FIGS. 6A and 6B compare peak signal to noise ratio to bit rates for operation of the invention relative to conventional techniques for data packet loss rates of 20% and 40%, respectively.

FIGS. 7A, 7B and 7C present a series of visual comparisons that demonstrate the efficacy of the techniques of the invention over conventional systems at a packet loss rate of 20%;

FIGS. 8A, 8B and 8C present a series of visual comparisons that demonstrate the efficacy of the techniques of the invention over conventional systems at a packet loss rate of 40%;

FIG. 9 illustrates supplemental context regarding H.264 decoding processes for decoding video encoded according to the optimizations of the invention;

FIG. 10 is a block diagram representing an exemplary non-limiting computing system or operating environment in which the present invention may be implemented; and

FIG. 11 illustrates an overview of a network environment suitable for service by embodiments of the invention.

### DETAILED DESCRIPTION

### Overview

As discussed in the background, conventional mode decision algorithms as applied to video encoding, such as H.264 video encoding, have focused on optimizing selection of intra mode as opposed to inter mode and optimal switching between intra and inter modes. However, no conventional systems have focused on generation of an optimal inter mode at the encoder, e.g., for P frames of an H.264 encoder without regard to intra mode. More specifically, with knowledge or statistical assumptions about existing channel condition(s), e.g., packet loss rate, and using the motion compensated frame to conceal the lost frame at the decoder, no conventional systems have thus far addressed how to generate an optimal inter mode to enhance error resilience.

Accordingly, in contrast to conventional systems that have focused on intra mode selection, in accordance with the invention, an inter mode for H.264 is optimally selected for enhanced error resilience. As mentioned, using a data partition technique, it is reasonable to assume that motion vectors will be received correctly at the decoder. Having access to the motion vectors at the decoder means that a motion compensated frame can be generated to conceal a lost frame. Within this framework, the invention thus generates an optimal inter mode for P frames at the encoder to minimize the impact of errors on the reconstructed motion compensated frame.

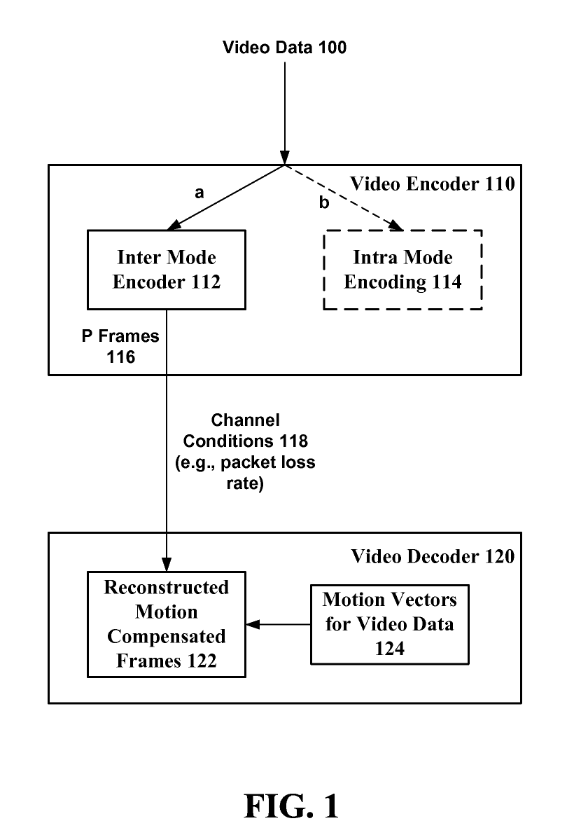

An encoding/decoding system to which the techniques of the invention can be applied is generally illustrated in FIG. 1. Original video data 100 to be compressed is input to a video encoder 110, which includes multiple encoding modes including at least an inter mode encoding component 112 and optionally, an intra mode encoding component 114, though the invention does not focus on selection or use of the intra mode encoding component.

For greater context, typically, the encoding algorithm defines when to use inter coding (path a) and when to use intra coding (path b) for various block-shaped regions of each picture. Inter coding uses motion vectors for block-based inter prediction to exploit temporal statistical dependencies between different pictures. Intra coding uses various spatial prediction modes to exploit spatial statistical dependencies in the source signal within a single picture. Thus, where conventional methodologies have focuses on optimizing intra coding decision making, the invention applies to the context of inter mode decisions made by inter mode component 112.

Additional steps are also applied to the video data 100 before inter mode encoder 112 operates (e.g., breaking the data up into slices and macro blocks) and after encoder 112 operates as well (e.g., further transformation/compression), but a result of inter mode encoding is to produce H.264 P frames 116. In accordance with the invention, based on channel conditions 118, e.g., packet loss rate, and an assumption that motion vectors 124 for the video data have been received correctly by the decoder 120, the invention enhances error resilience of the encoding of P frames 116 by optimally generating an inter mode for video data 100 as it is encoded. As a result, the reconstructed motion compensated frames 122 generated by video decoder 120 based on motion vectors 124 exhibit superior visual quality compared to sub-optimal conventional methodologies.

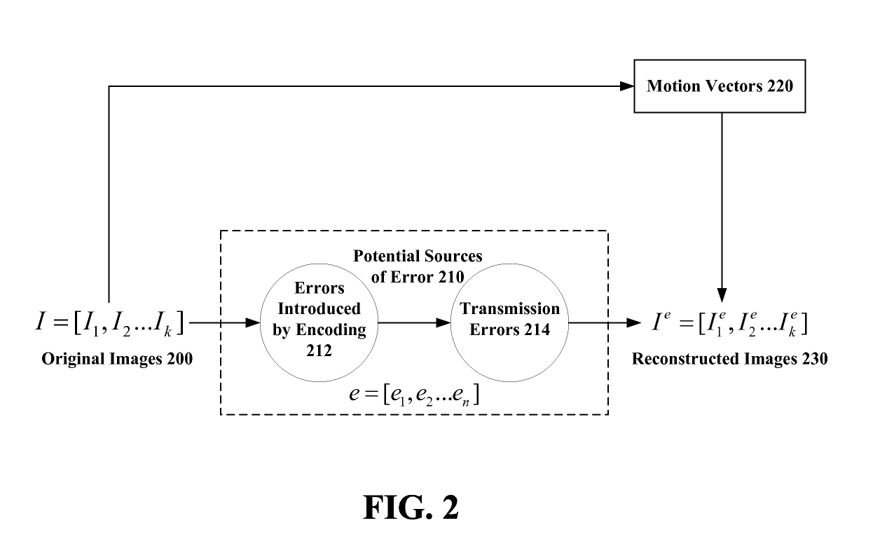

Generally speaking, as shown in FIG. 2, when encoding a set of original images 200, e.g., I₁, I_{2,} . . . , Iₖ, a variety of errors 210, e.g., e₁, e_{2,} . . . , eₙ, can occur either as part of errors 212 introduced by lossy encoding itself, e.g., errors due to quantization, averaging, etc., or transmission errors 214, e.g., bits that don't make it to the decoder. With the invention, an assumption is made that the motion vectors 220 will be sent to the encoder with a high priority, and thus will be available to help form reconstructed images 230 to conceal lost data in a presently decoded frame.

More specifically, in accordance with the invention, it is noted generally that expected end-to-end distortion is determined by three terms: residue energy, quantization error and propagation error. However, as mentioned, when the context is limited to inter mode decision making for video encoding for enhanced error resilience rather than inter/intra mode switching, the first two terms are sufficient for determining end-to-end distortion, i.e., the optimal method for selecting inter mode does not depend on propagation error. The invention applies an optimal Lagrangian parameter that is proportional to the error-free Lagrangian parameter with a scale factor determined by packet loss rate. According to the invention, with a cost function based on residue energy and quantization error and the optimal Lagrangian parameter, the invention selects the optimal inter mode to use during encoding for maximum error resilience.

Various embodiments and further underlying concepts of the inter mode selection systems and processes of the invention are described in more detail below.

### Optimal Inter Mode Selection

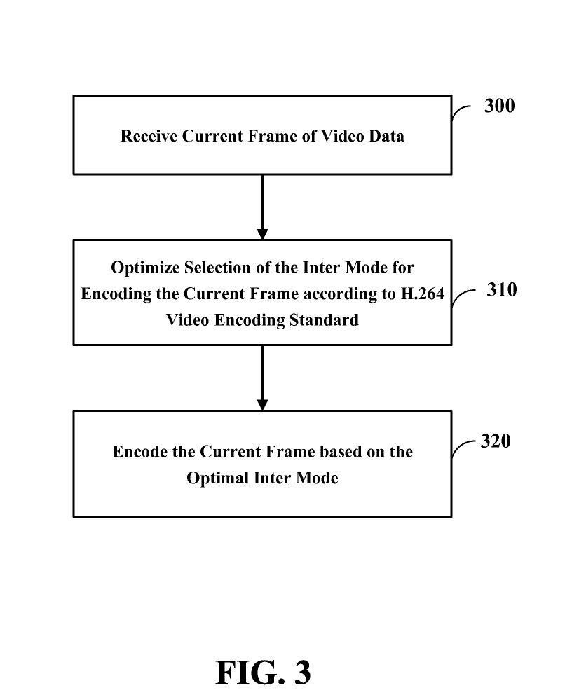

As mentioned, in accordance with embodiments of the invention, a rate distortion optimized inter mode decision method is proposed to enhance the error resilience of the H.264 video coding standard. As generally shown in the flow diagram of FIG. 3, at 300, a current frame of video data is received in a sequence of frames of video data. With the invention, at 310, an optimal inter mode is selected for encoding the current frame according to the H.264 video encoding standard. Then, at 320, based on the selection of the optimal inter mode, the current frame is encoded according to the H.264 standard. In this regard, a determination of the expected end-to-end distortion is used rather than source coding distortion, which leads to an optimal Lagrangian parameter.

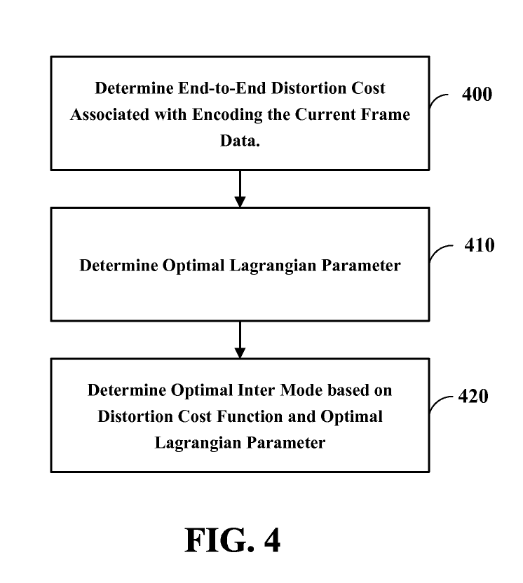

FIG. 4 illustrates an exemplary process for determining an optimal inter mode for a video encoding standard, such as H.264 video encoding, in accordance with the invention. At 400, the end-to-end distortion cost associated with encoding the current frame of a sequence of frames being encoded is determined. Then, the optimal Lagrangian parameter is determined at 410. Advantageously, at 420, the optimal inter mode for H.264 encoding can be selected based on the distortion cost determined at 400 and the optimal Lagrangian Parameter determined at 410.

Based on the assumption that the motion vectors are transmitted with high priority and thus will be correctly received at the decoder, the expected end-to-end distortion function is generated by three terms: residue energy, quantization error and propagation error in the previous frame. However, since the invention is directed to inter mode decision making, the first two terms are sufficient. In this regard, with a distortion function based on residue energy and quantization error, and a corresponding optimal Lagrangian parameter, optimized inter mode selections are made that improve the error resilience of the encoding process in accordance with the invention.

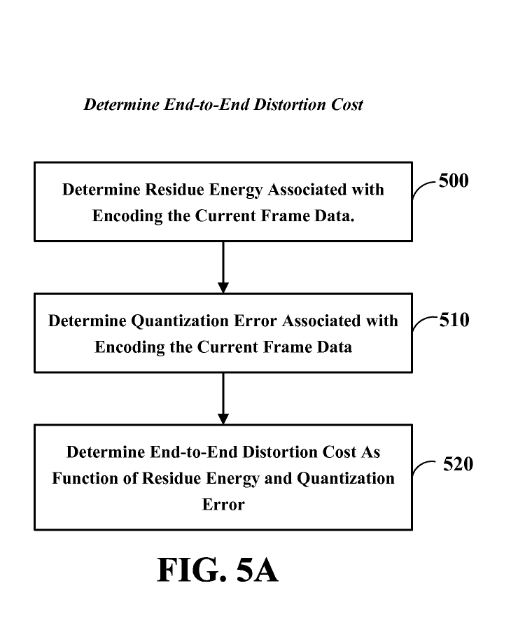

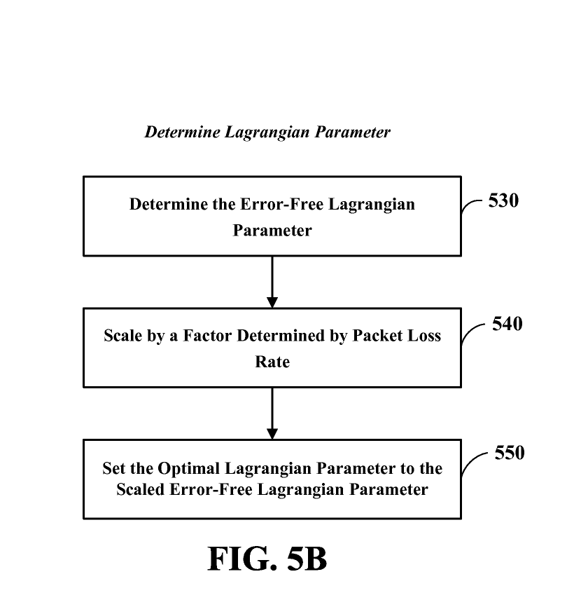

FIG. 5A illustrates an exemplary, non-limiting flow diagram for determining end-to-end distortion cost in connection with selecting an optimal inter mode for encoding video in accordance with the invention. At 500, the residue energy associated with encoding the current frame data is determined. At 510, the quantization error associated with encoding the current frame is determined. At 520, the end-to-end distortion cost can then be calculated as a function of residue energy determined at 500 and quantization error determined at 510.

FIG. 5B in turn illustrates an exemplary, non-limiting flow diagram for determining an optimal Lagrangian parameter for a rate distortion optimization equation as described herein. At 530, the Lagrangian Parameter is computed which would result under transmission error-free conditions. This “error-free” Lagrangian Parameter is then scaled by a factor based on the expected channel conditions from encoder to decoder at 540. At 550, the optimal Lagrangian parameter is set to the error-free Lagrangian parameter as scaled based on the channel conditions, e.g., packet loss rate.

With respect to expected end-to-end distortion determined in connection with selecting the inter mode for encoding in accordance with the invention, some notations are first defined for the following discussion. Herein, fᵢ refers to the original i^{th} frame, \hat{f}ᵢ₋₁ refers to the (i-1)^{th} error-free reconstructed frame, and \tilde{f}ᵢ₋₁ refers to the actual (i-1)^{th} reconstructed frame at the decoder, which can become corrupted due to packet loss. For a predictive coding standard, Equation 1 pertains:

fᵢ=\hat{f}ᵢ₋₁(mv)+eᵢ Eqn. 1

\tilde{f}ᵢ₋₁=\hat{f}ᵢ₋₁+\tilde{e}ᵢ₋₁ Eqn. 2

where eᵢ is the residue of frame i and \tilde{e}ᵢ₋₁ is the propagation error in the (i-1)^{th} frame.

As mentioned, by using a data partition technique, the motion vector(s) can be assumed to be received correctly at the decoder. Thus, if a current frame is lost, only the residue of current frame is lost, i.e., the portion of the original signal not represented by the motion compensated frame constructed from the motion vector(s). Therefore, the correctly received motion vector can always be used to conceal the lost frame. According to this notation, the reconstructed version of current frame \tilde{f}ᵢ can thus be expressed as:

\tilde{f}ᵢ^{loss}=\tilde{f}ᵢ₋₁(mv) Eqn. 3

\tilde{f}ᵢ^{lossless}=\tilde{f}ᵢ₋₁(mv)+êᵢ Eqn. 4

where \tilde{f}ᵢ^{loss} and \tilde{f}ᵢ^{lossless} stand for the reconstructed version of current frame when current frame is lost and correctly received, respectively. And êᵢ is the quantized residue of the current frame.

Combining Equations 1, 2, 3 and 4, the difference between the original value and the reconstructed value at the decoder of current frame can be expressed as follows, leading to Equations 5 and 6:

$$\begin{matrix}\begin{matrix}{e}_{i}^{loss} = {f}_{i} - {\tilde{f}}_{i}^{loss} \\ = {f}_{i} - {\tilde{f}}_{i - 1} ( mv ) \\ = {f}_{i} - {\hat{f}}_{i - 1} ( mv ) - {\tilde{e}}_{i - 1}\end{matrix} \\ {e}_{i}^{loss} = {e}_{i} - {\tilde{e}}_{i - 1} & Eqn . 5 \\ \begin{matrix}{e}_{i}^{lossless} = {f}_{i} - {\tilde{f}}_{i}^{lossless} \\ = {f}_{i} - {\tilde{f}}_{i - 1} ( mv ) - {\tilde{e}}_{i} \\ = {f}_{i} - {\hat{f}}_{i - 1} ( mv ) - {\tilde{e}}_{i - 1} - {\hat{e}}_{i}\end{matrix} \\ {e}_{i}^{lossless} = {e}_{i} - {\hat{e}}_{i} - {\tilde{e}}_{i - 1} & Eqn . 6\end{matrix}$$

where eᵢ^{loss} and eᵢ^{lossless} stand for the residue, i.e., the difference between the motion compensated frame and the original frame, when the current frame is lost and correctly received, respectively.

According to Equations 5 and 6, the reconstructed distortions for eᵢ^{loss} and eᵢ^{lossless} shown as expected mean square error are respectively derived as follows in Equations 7 and 8:

Dᵢ^{loss}+E(eᵢ^{loss})²=E(eᵢ−\tilde{e}ᵢ₋₁)²

Dᵢ^{loss}=Eeᵢ²−2Eeᵢ\tilde{e}ᵢ₋₁+E\tilde{e}ᵢ₋₁² Eqn. 7

Dᵢ^{lossless}=E(eᵢ^{lossless})²=E(eᵢ−êᵢ\tilde{e}ᵢ₋₁)²

Dᵢ^{lossless} =El(eᵢ−êᵢ)²−2E(eᵢ−êᵢ)\tilde{e}ᵢ₋₁+E\tilde{e}ᵢ₋₁² Eqn. 8

Assuming that the residue eᵢ and the quantized residue êᵢ are both uncorrelated with the propagation error in previous frame \tilde{e}_{i 1}, and the mean of the residue Eeᵢ and quantized residue Eêᵢ are both equal to zero, then Equations 9 and 10 pertain as follows:

Eeᵢ\tilde{e}ᵢ₋₁EeᵢE\tilde{e}ᵢ₋₁=0 Eqn. 9

E(eᵢ−êᵢ)\tilde{e}ᵢ₋₁=(Eeᵢ−Eêᵢ)E\tilde{e}ᵢ₋₁=0 Eqn. 10

Combining Equations 7, 8, 9 and 10, and assuming a packet loss rate of p, leads to a determination of the expected end-to-end distortion as shown in Equation 11 as follows:

$$\begin{matrix}E ( D ) = {pD}_{i}^{loss} + ( 1 - p ) {D}_{i}^{lossless} \\ = p [ {Ee}_{i}^{2} - 2 {Ee}_{i} {\tilde{e}}_{i - 1} + E {\tilde{e}}_{i - 1}^{2} ] + \\ ( 1 - p ) [ {E ( {e}_{i} - {\hat{e}}_{i} )}^{2} - 2 E ( {e}_{i} - {\hat{e}}_{i} ) {\tilde{e}}_{i - 1} + E {\tilde{e}}_{i - 1}^{2} ] \\ = {pEe}_{i}^{2} + ( 1 - p ) {E ( {e}_{i} - {\hat{e}}_{i} )}^{2} + E {\tilde{e}}_{i - 1}^{2} \\ = {pD}_{r} + ( 1 - p ) {D}_{q} + {D}_{p}\end{matrix} \qquad Eqn . 11$$

where Dᵣ=Eeᵢ² is the residue energy, D_{q}=E(eᵢ−êᵢ)² is the quantized distortion, and Dₚ=E\tilde{e}ᵢ₋₁² is the propagation distortion in the previous frame.

### Rate Distortion Optimized Inter Mode Decision

Having set forth the above foundation, by way of further context for inter mode decision making, the H.264 video coding standard allows a rich set of inter coding modes, varying from 4×4 to 16×16. In this regard, for each macro block, or MB, the best inter mode is chosen by minimizing the Lagrangian equation given by:

J₀D_{q}+λ₀R Eqn. 12

λ₀ is a Lagrangian multiplier associated with bit rate and generally, the bit rate R is assumed to be a function of the distortion D as follows:

$$R ( D ) = α log ( \frac{{D}_{r}}{{D}_{q}} ) \qquad Eqn . 13$$

Therefore, for an error-free channel, the Lagrangian parameter can be generated by taking derivatives over D_{q} as shown in Equation 14:

$$\frac{\partial {J}_{0}}{\partial {D}_{q}} = 1 - {λ}_{0} α \frac{1}{{D}_{q}} = 0 ⇒ {λ}_{0} = \frac{{D}_{q}}{α} \qquad Eqn . 14$$

Thus, for an error-prone channel, it is desirable to minimize the following Lagrangian equation, which can be expanded to Equation 15:

$$\begin{matrix}J = E ( D ) + λ R \\ = {pD}_{r} + ( 1 - p ) {D}_{q} + {D}_{p} + λ R\end{matrix} \\ J = {pD}_{r} + ( 1 - p ) {D}_{q} + {D}_{p} + λ α log ( \frac{{D}_{r}}{{D}_{q}} ) \qquad Eqn . 15$$

Since the invention is concerned with inter mode decision making, the propagation distortion in the previous frame Dₚ can be assumed to be independent of inter mode. Accordingly, only Dᵣ and D_{q} affect inter mode decision, reducing Equation 15 to Equation 16, as follows:

$${min}_{mode} J = {min}_{mode} {pD}_{r} + ( 1 - p ) {D}_{q} + λα log ( \frac{{D}_{r}}{{D}_{q}} ) \qquad Eqn . 16$$

Equation 16 reveals that J is an objective function which monotonically increases in Dᵣ and which is convex with respect to D_{q}. Therefore, when Dᵣ is fixed, the equation can be minimized over D_{q} as follows:

$$\begin{matrix}\frac{\partial J}{\partial {D}_{q}} = ( 1 - p ) - λα \frac{1}{{D}_{q}} \\ = 0 ⇒ λ \\ = ( 1 - p ) \frac{{D}_{q}}{α} \\ = ( 1 - p ) {λ}_{0}\end{matrix} \qquad Eqn . 17$$

Equation 16 can then be re-written as follows:

$${min}_{mode} J = {min}_{mode} {pD}_{r} + ( 1 - p ) {D}_{q} + ( 1 - p ) {λ}_{0} R \\ {min}_{mode} J = {min}_{mode} \frac{p}{1 - p} {D}_{r} + {D}_{q} + {λ}_{0} R \qquad Eqn . 18$$

Accordingly, in various non-limiting embodiments, the best inter mode is chosen by minimizing the cost function represented by Equation 18. Thus, residue energy, quantized distortion and packet loss rate are all seen to influence the choice of optimal inter mode.

Since the invention mainly focuses on inter mode selection, a direct comparison with other methods that have focused on inter/intra mode switching is not possible on an apples-to-apples basis. However, the invention can be compared with an H.264 error-free encoder by simulating identical loss conditions. As noted above and as demonstrated by Equation 16, when focusing on inter mode selection, the residue energy (concealment distortion), rather than propagation distortion, contributes to the mode selection. It is also noted, if it is assumed that the residue energy (concealment distortion) is independent of the mode selection, that the objective function returns or reduces to the H.264 error-free encoder objective function.

For non-limiting demonstration, an exemplary video sequence called “foreman” was tested. The test sequence was first encoded by using an H.264 error-free encoder and also encoded using the proposed method. Then, by using the same error pattern files to simulate the channel characteristic and adopting the same concealment method, i.e., using motion compensated frames to conceal the lost frames, different reconstructed videos are generated at the decoder. In the example, the first frame is encoded as I frame and the successive frames are encoded as P frames. Since the invention applies to inter mode selection, no intra mode is used for the P frames. The peak signal to noise ratio (PSNR) is computed by comparing with the original video sequence. The packet loss rates at 20% and 40% were then tested.

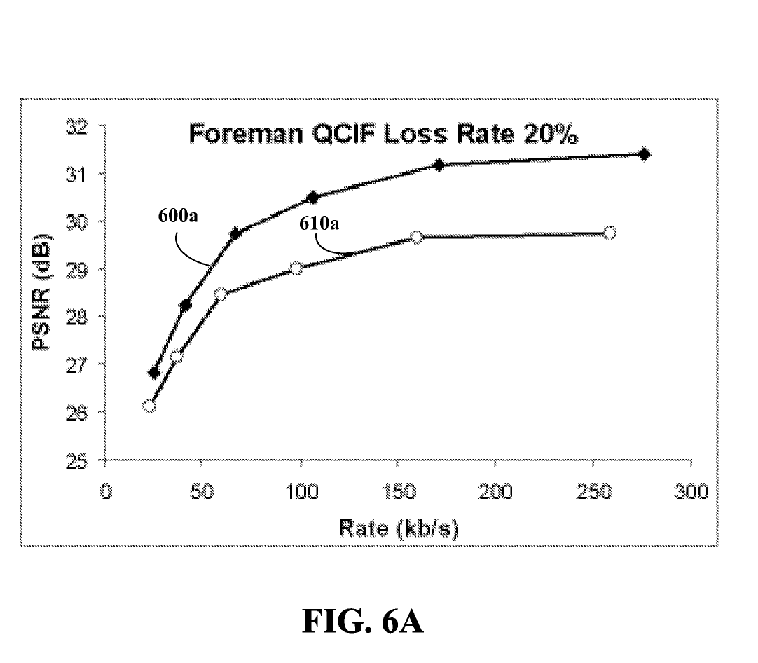

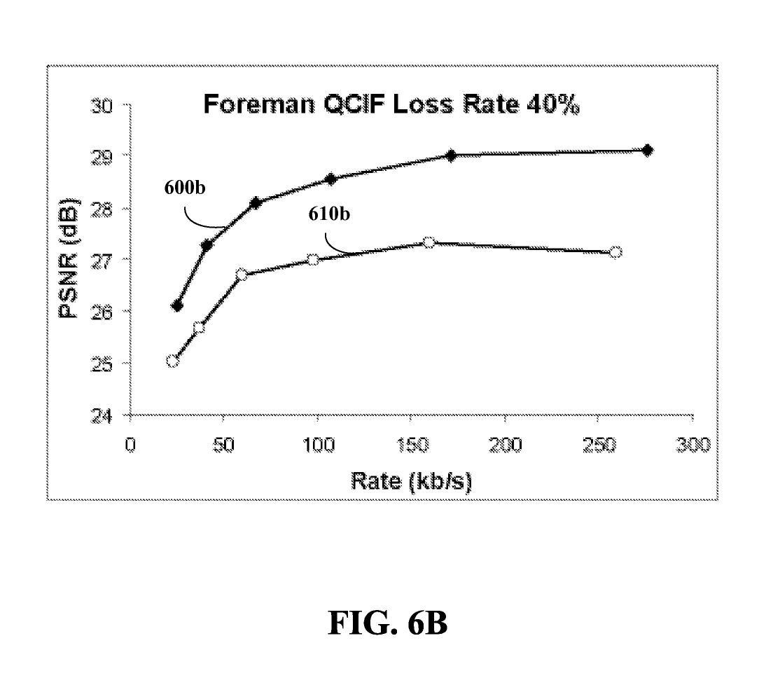

FIG. 6A illustrates representative performance of a sequence of images “Foreman(QCIF)” with a packet loss rate of 20% using conventional H.264 techniques as compared to use of the invention. Curve 600a represents PSNR versus bit rate for the performance of the invention, which is compared to curve 610a representing PSNR versus bit rate for the performance of an H.264 error-free decoder.

Similarly, FIG. 6B illustrates representative performance of a sequence of images “Foreman(QCIF)” with a packet loss rate of 40% using conventional H.264 techniques as compared to use of the optimal inter mode of the invention. Curve 600b represents PSNR versus bit rate for the performance of the invention, which is compared to curve 610b representing PSNR versus bit rate for the performance of an H.264 error-free decoder.

Thus, the comparison of Bit rate v. PSNR curves between the proposed algorithm and an H.264 error free encoder is shown in FIGS. 6A and 6B, respectively. Inspection of the curves demonstrates the performance of the invention is much better than an H.264 error free encoder, for different loss rates as well. In this regard, on average, at the same bit-rate, the invention provides gains of over 1 dB compared with an H.264 error free encoder, which demonstrates the efficacy of the invention. It is also observed with the invention that when the packet loss rate increases, the performance gains of the invention are realized, or increase, even more. This is reasonable, since as the above equations such as Equation 18 indicate, when the packet loss rate p increases, the residue energy term

$$\frac{p}{1 - p} {D}_{r}$$

plays a more significant role.

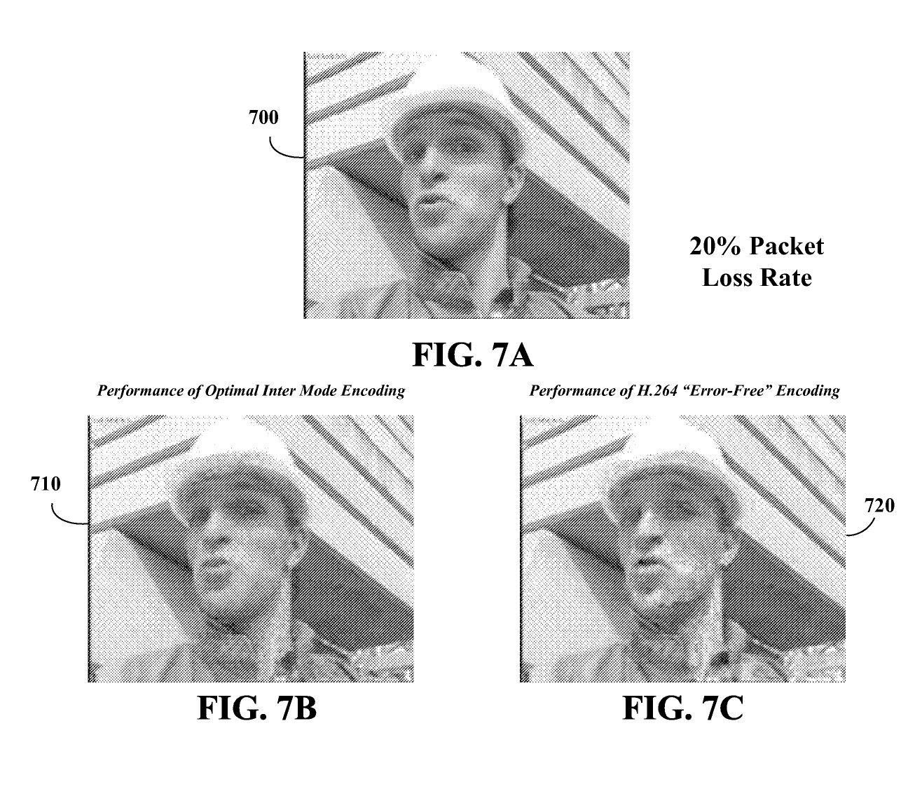

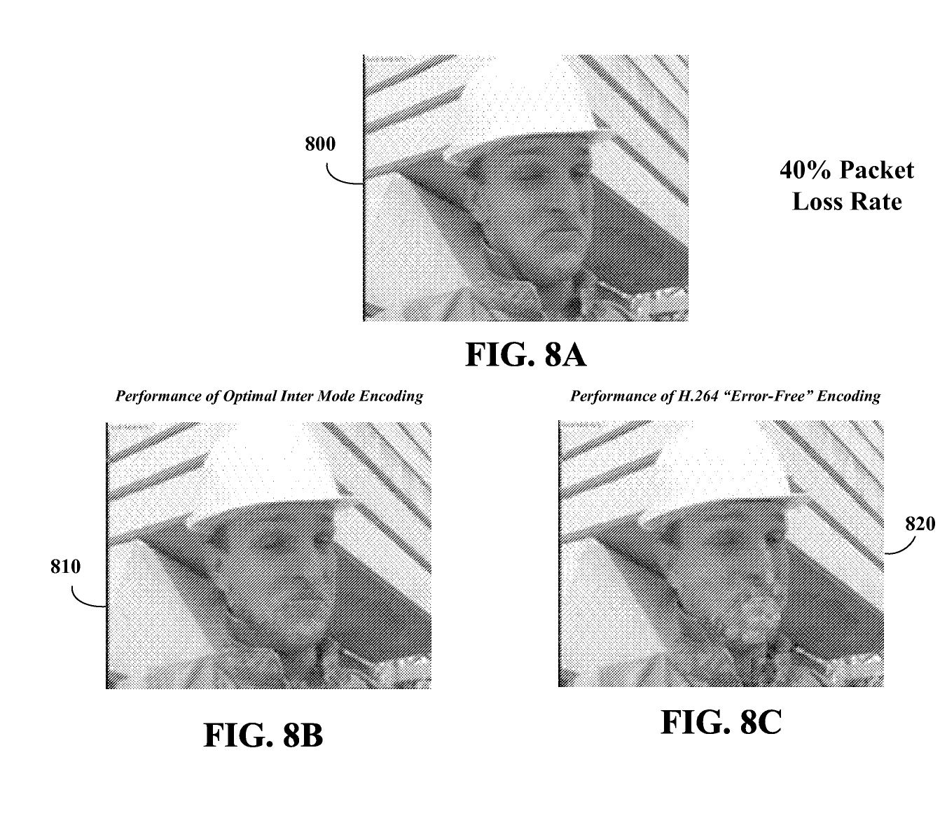

The visual quality of the reconstructed video can also be examined via the image comparisons of FIGS. 7A to 7C at a packet loss rate of 20% and via the image comparisons of FIGS. 8A to 8C at a packet loss rate of 40%. For instance, FIGS. 7A and 8A represent two original frames of the “foreman” sample video. FIGS. 7B and 8B represent reconstructed frames of the two original frames applying the optimal inter mode selection techniques of the invention. FIGS. 7C and 8C in turn show the results generated by an H.264 error-free encoder, for simple visual comparison to FIGS. 7B and 8B, respectively. In this regard, upon a simple visual inspection, the quality of the frames reconstructed by the invention are observed to be much better than the quality of the frames generated by the H.264 error-free encoder, e.g., the invention manifests fewer “dirty” artifacts.

As described above in various non-limiting embodiments of the invention, a rate distortion optimized inter mode decision algorithm is used to enhance the error resilient capabilities of the H.264 video coding standard. Based on the assumption that the motion vectors are always received at the decoder, the expected end-to-end distortion is determined by three terms: residue energy, quantization distortion, and propagation distortion in the previous frame, the first two of which apply to inter mode selection. Focused on an optimal inter mode selection, the expected end-to-end distortion is determined and used to select the best inter mode for encoding P frames. With such distortion function and the corresponding optimal Lagrangian parameter, results demonstrate improved error resilience, both visually and mathematically. In one non-limiting embodiment, the optimal Lagrangian parameter is set to be proportional to an error-free Lagrangian parameter with a scale factor determined by packet loss rate.

### Supplemental Context for H.264 Video Coding

The following description sets forth further details about the H.264 standard for supplemental background or additional context about the standard; for the avoidance of doubt, however, in the absence of an express statement to the contrary, these additional details should not be considered limiting on the various non-limiting embodiments of the invention set forth above, nor on the claims defining the spirit and scope of the invention appended below.

H.264/AVC is a contemporary and widely used video coding standard. The goals of the standard include enhanced compression efficiency, network friendly video representation for interactive applications, e.g., video telephony, and non-interactive applications, e.g., broadcast applications, storage media applications, and others as well. H.264/AVC provides gains in compression efficiency up to 50% over a wide range of bit rates and video resolutions compared to previous standards. Compared to previous standards, the decoder complexity is about four times that of MPEG-2 and two times that of MPEG-4 visual simple profile.

Relative to prior video coding standards, H.264/AVC introduces the following non-limiting features. In order to reduce the blocking artifacts, an adaptive loop filter can be used in the prediction loop to reduce blocking artifacts. As mentioned as an aside, a prediction scheme called intra prediction can be used that exploits spatial redundancy. In this scheme, data from previously processed macro blocks is used to predict the data for the current macro block in the current encoding frame. Previous video coding standards use an 8×8 real discrete cosine transform (DCT) to exploit the spatial redundancy in the 8×8 block of image data. In H.264/AVC, a smaller 4×4 integer DCT is used which significantly reduces ringing artifacts associated with the transform.

Also, with inter mode, various block sizes from 16×16 to 4×4 are allowed to perform motion compensation prediction. Previous video coding standards used a maximum of half-pixel accuracy for motion estimation. Inter prediction mode of H.264 also allows multiple reference frames for block-based motion compensation prediction. Context-adaptive variable length coding (CAVLC) and context-adaptive binary arithmetic coding (CABAC) can also be used for entropy encoding/decoding, which improves compression by 10%, compared to previous schemes.

The expected encoding algorithm selects between inter and intra coding for block-shaped regions of each picture. As mentioned in connection with various embodiments of the invention that set an optimal inter mode, inter coding uses motion vectors for block-based inter prediction to exploit temporal statistical dependencies between different pictures. Intra coding (not the focus of the invention) uses various spatial prediction modes to exploit spatial statistical dependencies in the source signal within a single picture. Motion vectors and intra prediction modes may be specified for a variety of block sizes in the picture.

The residual signal remaining after intra or inter prediction is then further compressed using a transform to remove spatial correlation inside each transform block. The transformed blocks are then quantized. The quantization is an irreversible process that typically discards less important visual information while forming a close approximation to the source samples. Finally, the motion vectors or intra prediction modes are combined with the quantized transform coefficient information and encoded using either context-adaptive variable length codes or context-adaptive arithmetic coding.

It bears repeating that the present description is for supplemental context regarding H.264 generally, and thus any features described herein are to be considered purely optional, unless expressly stated otherwise. Compressed H.264 bit-stream data is available on slice-by-slice basis whereas a slice is usually a group of macro blocks processed in raster scan order. Two slice types are supported in a baseline profile for H.264. In an I-slice, all macro blocks are encoded in intra mode. In a P-slice, some macro blocks are predicted using a motion compensated prediction with one reference frame among the set of reference frames and some macro blocks are encoded in intra mode. H.264 decoder processes the data on a macro block by macro block basis. For every macro block depending on its characteristics, it will be constructed by the predicted part of the macro block and the residual (error) part 955, which is coded using CAVLC.

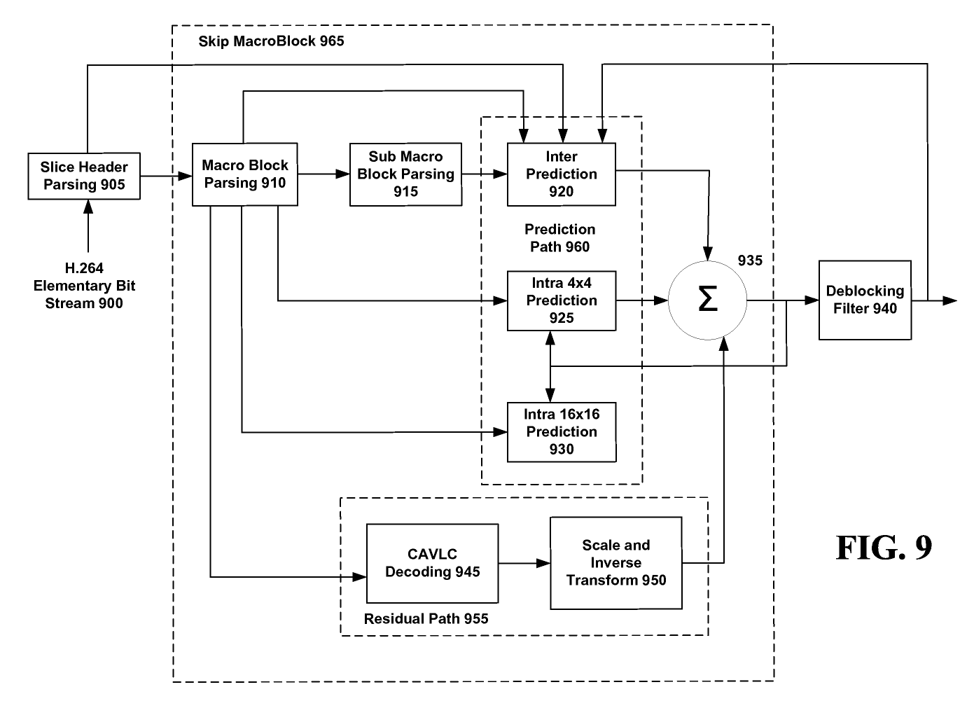

FIG. 9 shows an exemplary, non-limiting H.264 baseline profile video decoder system for decoding an elementary H.264 bit stream 900. H.264 bit-stream 900 passes through the “slice header parsing” block 905, which extracts information about each slice. In H.264 video coding, each macro block is categorized as either coded or skipped. If the macro block is skipped at 965, then the macro block is completely reconstructed using the inter prediction module 920. In this case, the residual information is zero. If the macro block is coded, then based on the prediction mode, it passes through the “Intra 4×4 prediction” block 925 or “Intra 16×16 prediction” block 930 or “Inter prediction” block 920. The output macro block is reconstructed at 935 using the prediction output from the prediction module and the residual output from the “scale and transform” module 950. Once all the macro blocks in a frame are reconstructed, de-blocking filter 940 will be applied for the entire frame.

The “macro block parsing module” 910 parses the information related to the macro block, such as prediction type, number of blocks coded in a macro block, partition type, motion vectors, etc. The “sub macro block” parsing module 915 parses the information if the macro block is split into sub macro blocks of one of the sizes 8×8, 8×4, 4×8, and 4×4 when the macro block is coded as inter macro block. If the macro block is not split into sub macro blocks, any of the three prediction types (Intra16×16, Intra4×4, or Inter) can be used.

In inter prediction module 920, the motion compensated predicted blocks are predicted from the previous frames, which are already decoded.

Intra prediction means that the samples of a macro block are predicted by using the already transmitted macro blocks of the same image. In H.264/AVC, two different types of intra prediction modes are available for coding luminance component of the macro block. The first type is called INTRA_{—}4×4 mode and the second type is called INTRA_{—}16×16 mode. In INTRA_{—}4×4 prediction mode, each macro block of size 16×16 is divided into small blocks of size 4×4 and prediction is carried out individually for each sub-block using one of the nine prediction modes available. In INTRA_{—}16×16 prediction mode, the prediction is carried out at macro block level using one of the four prediction modes available. Intra prediction for chrominance components of a macro blocks is similar to the INTRA_{—}16×16 prediction of the luminance component.

The H.264/AVC baseline profile video decoder can use a CAVLC entropy coding method to decode the encoded quantized residual transform coefficients. In CAVLC module 945, the number of non-zero quantized transform coefficients, the actual size and the position of each coefficient are decoded separately. The tables used for decoding these parameters are adaptively changed depending on the previously decoded syntax elements. After decoding, the coefficients are inverse zigzag scanned and form a 4×4 blocks, which are given to scale and inverse transform module 950.

In scale and inverse transform module 950, inverse quantization and inverse transformation are performed on the decoded coefficients and form residual data suitable for inverse prediction. Three different types of transforms are used in H.264 standard. The first type is 4×4 inverse integer discrete cosine transform (DCT), which is used to form the residual blocks of both luminance and chrominance blocks. A second type is a 4×4 inverse Hadamard transform, which is used to form the DC coefficients of the 16 luminance blocks of the INTRA_{—}16×16 macro blocks. A third transform is a 2×2 inverse Hadamard transform, which is used to form the DC coefficients of the chrominance blocks.

The 4×4 block transform and motion compensation prediction can be the source of blocking artifacts in the decoded image. The H.264 standard typically applies an in-loop deblocking filter 940 to remove blocking artifacts.

### Exemplary Computer Networks and Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with optimization algorithms and processes performed in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the optimization algorithms and processes of the invention.

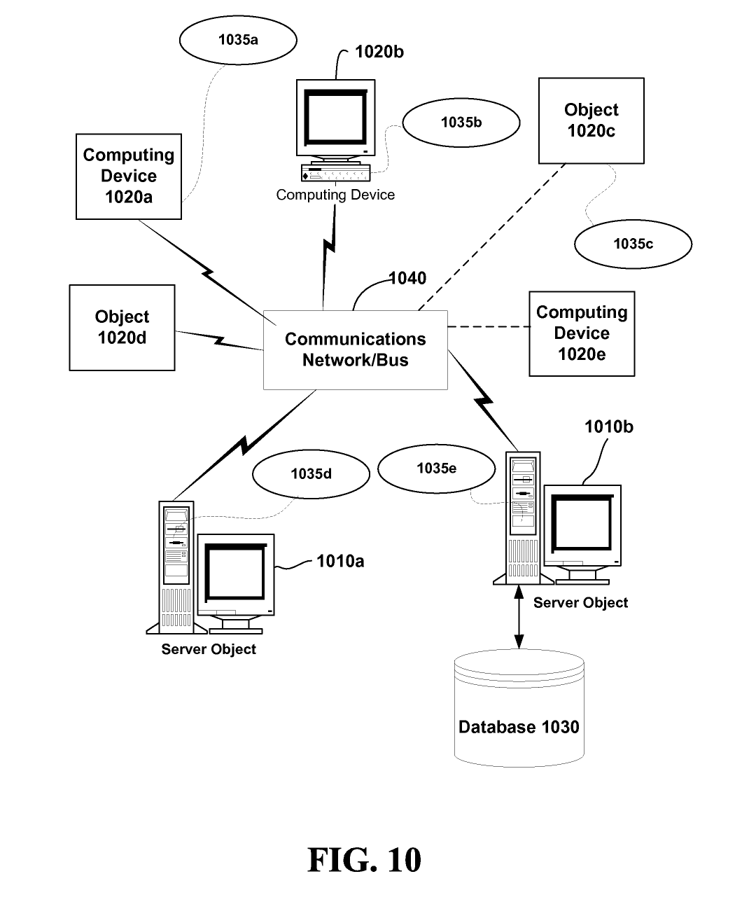

FIG. 10 provides a schematic diagram of an exemplary networked or distributed computing environment. The distributed computing environment comprises computing objects 1010a, 1010b, etc. and computing objects or devices 1020a, 1020b, 1020c, 1020d, 1020e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1040. This network may itself comprise other computing objects and computing devices that provide services to the system of FIG. 10, and may itself represent multiple interconnected networks. In accordance with an aspect of the invention, each object 1010a, 1010b, etc. or 1020a, 1020b, 1020c, 1020d, 1020e, etc. may contain an application that might make use of an API, or other object, software, firmware and/or hardware, suitable for use with the design framework in accordance with the invention.

It can also be appreciated that an object, such as 1020c, may be hosted on another computing device 1010a, 1010b, etc. or 1020a, 1020b, 1020c, 1020d, 1020e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 1002.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 10, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices may be processing data or requesting services or tasks that may implicate the optimization algorithms and processes in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 10 illustrates an exemplary networked or distributed environment, with server(s) in communication with client computer (s) via a network/bus, in which the present invention may be employed. In more detail, a number of servers 1010a, 1010b, etc. are interconnected via a communications network/bus 1040, which may be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to communicate data over a network.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. may also serve as clients 1020a, 1020b, 1020c, 1020d, 1020e, etc., as may be characteristic of a distributed computing environment.

As mentioned, communications may be wired or wireless, or a combination, where appropriate. Client devices 1020a, 1020b, 1020c, 1020d, 1020e, etc. may or may not communicate via communications network/bus 14, and may have independent communications associated therewith. For example, in the case of a TV or VCR, there may or may not be a networked aspect to the control thereof. Each client computer 1020a, 1020b, 1020c, 1020d, 1020e, etc. and server computer 1010a, 1010b, etc. may be equipped with various application program modules or objects 1035a, 1035b, 1035c, etc. and with connections or access to various types of storage elements or objects, across which files or data streams may be stored or to which portion(s) of files or data streams may be downloaded, transmitted or migrated. Any one or more of computers 1010a, 1010b, 1020a, 1020b, 1020c, 1020d, 1020e, etc. may be responsible for the maintenance and updating of a database 1030 or other storage element, such as a database or memory 1030 for storing data processed or saved according to the invention. Thus, the present invention can be utilized in a computer network environment having client computers 1020a, 1020b, 1020c, 1020d, 1020e, etc. that can access and interact with a computer network/bus 1040 and server computers 1010a, 1010b, etc. that may interact with client computers 1020a, 1020b, 1020c, 1020d, 1020e, etc. and other like devices, and databases 1030.

### Exemplary Computing Device

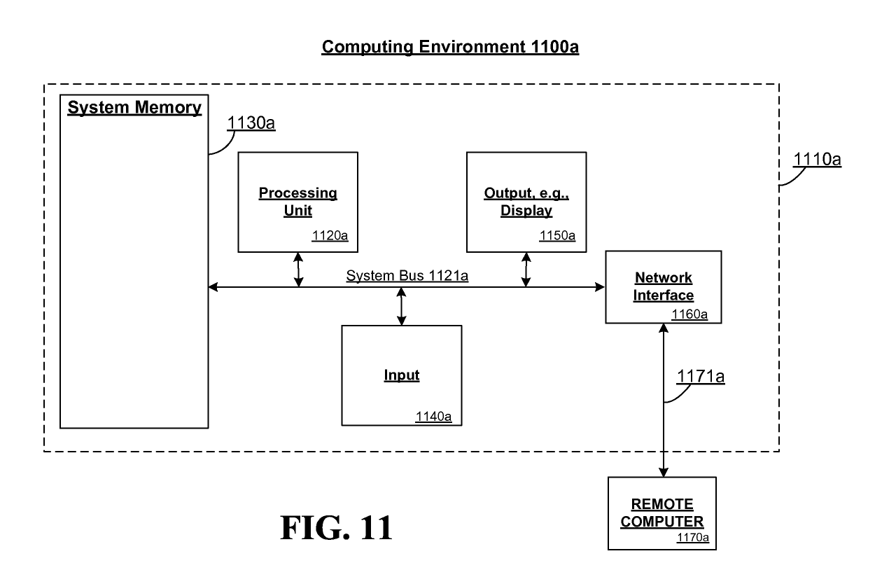

As mentioned, the invention applies to any device wherein it may be desirable to communicate data, e.g., to a mobile device. It should be understood, therefore, that handheld, portable and other computing devices and computing objects of all kinds are contemplated for use in connection with the present invention, i.e., anywhere that a device may communicate data or otherwise receive, process or store data. Accordingly, the below general purpose remote computer described below in FIG. 11 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 11 thus illustrates an example of a suitable computing system environment 1100a in which the invention may be implemented, although as made clear above, the computing system environment 1100a is only one example of a suitable computing environment for a media device and is not intended to suggest any limitation as to the scope of use or functionality of the invention. Neither should the computing environment 1100a be interpreted as having any dependency or requirement relating to any one or combination of components illustrated in the exemplary operating environment 1100a.

With reference to FIG. 11, an exemplary remote device for implementing the invention includes a general purpose computing device in the form of a computer 1110a. Components of computer 1110a may include, but are not limited to, a processing unit 1120a, a system memory 1130a, and a system bus 1121a that couples various system components including the system memory to the processing unit 1120a. The system bus 1121a may be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a may include computer storage media in the form of volatile and/or nonvolatile memory such as read only memory (ROM) and/or random access memory (RAM). A basic input/output system (BIOS), containing the basic routines that help to transfer information between elements within computer 1110a, such as during start-up, may be stored in memory 1130a. Memory 1130a typically also contains data and/or program modules that are immediately accessible to and/or presently being operated on by processing unit 1120a. By way of example, and not limitation, memory 1130a may also include an operating system, application programs, other program modules, and program data.

The computer 1110a may also include other removable/non-removable, volatile/nonvolatile computer storage media. For example, computer 1110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1121a through a non-removable memory interface such as an interface, and a magnetic disk drive or optical disk drive is typically connected to the system bus 1121a by a removable memory interface, such as an interface.

A user may enter commands and information into the computer 1110a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1120a through user input 1140a and associated interface(s) that are coupled to the system bus 1121a, but may be connected by other interface and bus structures, such as a parallel port, game port or a universal serial bus (USB). A graphics subsystem may also be connected to the system bus 1121a. A monitor or other type of display device is also connected to the system bus 1121a via an interface, such as output interface 1150a, which may in turn communicate with video memory. In addition to a monitor, computers may also include other peripheral output devices such as speakers and a printer, which may be connected through output interface 1150a.

The computer 1110a may operate in a networked or distributed environment using logical connections to one or more other remote computers, such as remote computer 1170a, which may in turn have media capabilities different from device 1110a. The remote computer 1170a may be a personal computer, a server, a router, a network PC, a peer device or other common network node, or any other remote media consumption or transmission device, and may include any or all of the elements described above relative to the computer 1110a. The logical connections depicted in FIG. 11 include a network 1171a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1110a is connected to the LAN 1171a through a network interface or adapter. When used in a WAN networking environment, the computer 1110a typically includes a communications component, such as a modem, or other means for establishing communications over the WAN, such as the Internet. A communications component, such as a modem, which may be internal or external, may be connected to the system bus 1121a via the user input interface of input 1140a, or other appropriate mechanism. In a networked environment, program modules depicted relative to the computer 1110a, or portions thereof, may be stored in a remote memory storage device. It will be appreciated that the network connections shown and described are exemplary and other means of establishing a communications link between the computers may be used.

While the present invention has been described in connection with the preferred embodiments of the various Figures, it is to be understood that other similar embodiments may be used or modifications and additions may be made to the described embodiment for performing the same function of the present invention without deviating therefrom. For example, one skilled in the art will recognize that the present invention as described in the present application may apply to any environment, whether wired or wireless, and may be applied to any number of such devices connected via a communications network and interacting across the network. Therefore, the present invention should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom.

While exemplary embodiments refer to utilizing the present invention in the context of particular programming language constructs, specifications or standards, the invention is not so limited, but rather may be implemented in any language to perform the optimization algorithms and processes. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for encoding video data in inter mode, comprising:
receiving current frame data of image frame data representing a sequence of images;
when encoding according to an inter mode for encoding the current frame data that uses motion vectors for block-based inter frame prediction based on temporal dependencies determined between frames of the image frame data, optimizing selection of the inter mode; and

2. The method of claim 1, wherein the optimizing includes determining an end-to-end distortion cost associated with encoding the current frame data.

3. The method of claim 2, wherein the optimizing includes determining a residue energy associated with encoding the current frame data.

4. The method of claim 2, wherein the optimizing includes determining a quantization error associated with encoding the current frame data.

5. The method of claim 3, wherein the optimizing includes determining a quantization error associated with encoding the current frame data.

6. The method of claim 1, wherein the optimizing includes determining an optimal Lagrangian parameter.

7. The method of claim 6, wherein the optimizing includes determining the optimal Lagrangian parameter as a function of expected packet loss rate from encoder to decoder.

8. The method of claim 7, wherein the optimizing includes determining the optimal Lagrangian parameter as a function of an error-free Lagrangian parameter with a scaling factor determined by packet loss rate.

9. The method of claim 1, wherein the optimizing includes optimizing the selection of an inter mode as defined by the H.264 video encoding standard.

10. The method of claim 9, wherein the encoding includes encoding a P frame of the image frame data according to the inter mode selected by the optimizing.

11. A computer readable medium comprising computer executable instructions for performing the method of claim 1.

12. A video encoding computing system for encoding video data, comprising:
at least one data store for storing a plurality of frames of video data; and
an encoding component that selects, for each predictor frame to be encoded, an optimal inter mode for an inter coding process of a video compression standard by at least minimizing a rate distortion cost function based on end-to-end distortion and at least one channel condition,
wherein the video coding standard includes at least an inter coding module for performing the inter coding process based on at least one motion vector derived from temporal correlation between frames of the plurality of frames and an intra coding module for encoding based on spatial correlation between frames of the plurality of frames.

13. The video encoding system of claim 12, wherein the encoding component determines the optimal inter mode based on an optimal Lagrangian parameter determined as a function of expected packet loss rate from encoder to decoder for a frame being encoded.

14. The video encoding system of claim 12, wherein the encoding component determines the amount of end-to-end distortion based on a residue energy and a quantization error associated with a frame being encoded.

15. The video encoding system of claim 12, wherein the encoding component includes an H.264 encoder for encoding the plurality of frames of video data according to the H.264 advanced video coding standard.

16. The video encoding system of claim 12, wherein the encoding component minimizes a rate distortion cost function based on end-to-end distortion and packet loss rate.

17. Graphics processing apparatus, including:
memory for storing video data including images;
at least one graphics processing unit (GPU) for processing the video data to encode the images represented by the video data according to the H.264 encoding standard in response to instructions received by the at least one GPU, whereby in response to receiving the instructions, the at least one GPU selects an optimal inter mode for encoding a current image of the images based on at least a residue energy and a quantized distortion associated with the current image, and encodes the current image based on the optimal inter mode.

18. Graphics processing apparatus according to claim 17, wherein the at least one GPU selects the optimal inter mode for encoding the current image based on a channel condition associated with a transmission channel for transmitting encoded images of the images to a H.264 decoder.

19. Graphics processing apparatus according to claim 18, wherein the at least one GPU selects the optimal inter mode for encoding the current image based on a packet loss rate associated with a transmission channel for transmitting encoded images of the images to a H.264 decoder.

20. Graphics processing apparatus according to claim 18, wherein the at least one GPU determines an end-to-end distortion cost based on the residue energy and quantized distortion.
